(19) United States
(12) Patent Application Publication
(10) Pub. No.: US 2008/0118343 A1
(43) Pub. Date: May 22, 2008

(54) COMBUSTION CONTROL FOR A GAS TURBINE

(75) Inventors: David Matthew Arthur, Cambridge (GB); Ann Patricia Dowling, Cambridge (GB)

Correspondence Address: MCCORMICK, PAULDING & HUBER LLP, CITY PLACE II, 185 ASYLUM STREET, HARTFORD, CT, 06103, US

(73) Assignee: ROLLS-ROYCE PLC, London (GB)

(21) Appl. No.: 11/935,640

(22) Filed: Nov. 6, 2007

(30) Foreign Application Priority Data
Nov. 16, 2006 (GB) 0622837.3

(51) Int. Cl. F03B 15/06

(52) U.S. Cl. 415/2.1

(57) ABSTRACT

A method for controlling instability in a combustion system comprising a combustion chamber and a passage external of the combustion chamber which supplies a secondary non-combustible fluid to the combustor chamber. The passage external to the combustion chamber is arranged such that the phase of perturbations in the mass flow of the secondary non-combustible fluid in the passage acts to reduce the amplitude of unsteady instability in the combustor chamber. Furthermore, the geometry of the external passage may be actively adjusted to tune the system if the frequency of the unstable instability differs from that for which the combustor was originally designed to attenuate.

### CROSS-REFERENCE TO RELATED APPLICATION

This application is entitled to the benefit of British Patent Application No. GB 0621001.7 filed on Oct. 21, 2006.

### FIELD OF THE INVENTION

The invention relates to combustor systems for gas turbine engines.

### BACKGROUND OF THE INVENTION

A significant limiting factor in the development and introduction of ultra-low NOₓ combustors is a propensity to combustion instabilities at lean mixture fractions. At lean air/fuel ratios (AFR) slight changes in the AFR can lead to large changes in heat release which can lead to an audible rumbling sound that may cause passenger discomfort or fatigue failure of engine components, depending on the frequency and amplitude of the instability.

Combustion instabilities are currently addressed in two ways: actively and passively. In an active control method the fuel supply is modulated at a frequency that is similar to that of the instability to be controlled. Modulation of the fuel is achieved through the use of a valve which, by operating at a frequency close to the combustor oscillation frequency, is subject to a significant amount of valve wear that raises reliability concerns and adds additional complexity to the system.

Passive control techniques involve either the modification of the convective time delay distribution by using multiple fuel injector locations that are collectively tuned to damp combustion oscillations through variation in equivalence ratio, introduced at varying phase angles, or the use of Helmholtz resonators, mounted on the periphery of the combustion chamber and which act to damp combustion oscillations at a particular frequency.

As the Helmholtz resonators, which comprise a resonator cavity and a resonator neck, are located in direct contact with the combustion chamber with the neck opening into the combustion cavity, it is necessary to provide cooling for the resonator and resonator neck to prevent damage thereto.

### SUMMARY OF THE INVENTION

It is an object of the present invention to seek to provide an improved method and apparatus for reducing the amplitude of combustion instabilities.

According to a first aspect of the invention there is provided a combustor arrangement for a gas turbine, the arrangement having a combustion chamber having a primary inlet at the upstream end thereof for the supply of a first volume of air to the combustion chamber and a secondary inlet downstream of the primary inlet for the supply of a second volume of air to the combustion chamber; a passage external of the combustion chamber for the supply of air to the secondary inlet; wherein the phase and amplitude of a standing wave in the passage at the secondary inlet is selected relative to the phase and amplitude of a standing wave at the primary inlet to minimise the amplitude of unsteady instability in the combustor chamber.

Preferably, the unsteady combustion due to the phase of the standing wave in the passage at the secondary inlet is anti-phase with the unsteady combustion due to the standing wave at the primary inlet.

Preferably the amplitude of the standing wave in the passage at the secondary inlet is substantially the same as the amplitude of the standing wave at the primary inlet.

Preferably, the passage is defined between an outer wall of the combustor and a casing extending around the combustor, and the arrangement further comprises a Helmholtz resonator having a resonator cavity and a resonator neck that extends between the cavity and the passage and which opens to the passage through an aperture in the casing.

The volume of the Helmholtz resonator may be selectively changed to adjust the phase and amplitude of the standing wave in the passage.

The passage may be defined between an outer wall of the combustor and a casing extending around the combustor, and the arrangement further comprises phase adjusting means for adjusting the phase of the standing wave in the passage.

The phase adjusting means may comprises a wall which is moveable to adjust the length of the passage.

Preferably, the secondary inlet is a dilution port.

Preferably, the primary inlet is a fuel injector.

Sensors means may be provided to detect or calculate the phase and amplitude of the standing wave in the passage at the secondary inlet.

Preferably, the sensor means comprises pressure transducers at the primary and dilution ports.

According to a second aspect of the invention there is provided a combustor arrangement for a gas turbine, the arrangement having a combustion chamber having a primary inlet at the upstream end thereof for the supply of a first volume of air to the combustion chamber and a secondary inlet downstream of the primary inlet for the supply of a second volume of air to the combustion chamber; a passage external of the combustion chamber for the supply of air to the secondary inlet; wherein a Helmholtz resonator is provided having a resonator cavity and a resonator neck, the resonator neck extending between the cavity and the passage for adjusting the phase and amplitude of a standing wave in the passage.

According to a third aspect of the invention there is provided a method for reducing the amplitude of instability in a combustion chamber within a combustor arrangement for a gas turbine having a combustion chamber having a primary inlet at the upstream end thereof for the supply of a first volume of air to the combustion chamber and a secondary inlet downstream of the primary inlet for the supply of a second volume of air to the combustion chamber; a passage external of the combustion chamber for the supply of air to the secondary inlet; wherein the method comprises the step of adjusting the phase and amplitude of a standing wave in the passage at the secondary inlet relative to the phase and amplitude of a standing wave at the primary inlet to minimise the amplitude of unsteady instability in the combustor chamber.

Preferably, the phase of combustion due to the standing wave in the passage at the secondary inlet is adjusted to be anti-phase with the phase of combustion due to the standing wave at the primary inlet.

Preferably, the amplitude of the standing wave in the passage at the secondary inlet is adjusted to give unsteady combustion of an amplitude that is substantially the same as the amplitude of the unsteady combustion due to the standing wave at the primary inlet.

Preferably, the passage is defined between an outer wall of the combustor and a casing extending around the combustor and is provided with a Helmholtz resonator having a resonator cavity and a resonator neck that extends between the cavity and the passage and which opens to the passage through an aperture in the casing, wherein the method comprises adjusting the volume of the resonator cavity to adjust the phase and amplitude of the standing wave in the passage.

The passage may be defined between an outer wall of the combustor and a casing extending around the combustor and is provided with a moveable end wall that may be moved, wherein the method comprises moving the moveable end wall to adjust the length of the passage to adjust the phase and amplitude of the standing wave in the passage.

The invention will now be described by way of example only with reference to the following drawings in which:

### BRIEF DESCRIPTION OF THE DRAWINGS

FIG. 1 depicts a schematic of an embodiment of a first combustor system in accordance with the invention

FIG. 2 depicts a schematic of a second embodiment of a combustor system in accordance with the invention.

FIG. 3 is a graphical representation of pressure instabilities in a first combustor arrangement.

FIG. 4 is a graphical representation of pressure instabilities in an optimised combustor arrangement according to the invention.

### DETAILED DESCRIPTION OF THE PREFERRED EMBODIMENTS

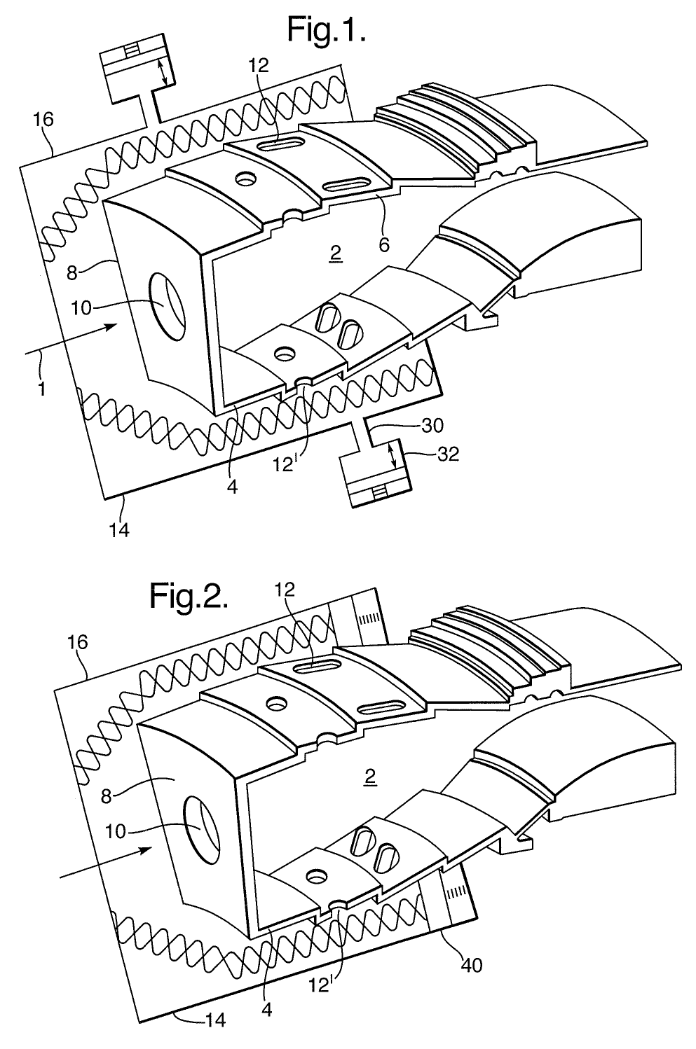

FIG. 1 depicts an annular combustion chamber 2 which consists of a single annular flame tube contained between a radially inner combustor wall 4 and a radially outer combustor wall 6. A stream of compressed air is supplied to the combustor generally in the direction of arrow 1. The upstream end of the chamber is bounded by a combustor head 8 which contains a circular array of apertures 10 which are circumferentially spaced (a single aperture is shown for clarity). The downstream end of the combustor leads to high pressure turbine nozzle guide vanes and then on to a turbine in the gas turbine engine.

The aperture 10 in the combustor head accepts a fuel injector (not shown), which injects fuel into the combustion chamber 2. Each fuel injector receives air from an upstream compressor which it mixes with the fuel to create a combustible mixture which is ignited either by an igniter, or by fuel burning in the combustion chamber. Ignited fuel generates a hot combustion gas at a temperature of the order 2100° C. which is too hot for entry to the turbine. The volume of air flowing through the injectors serve to reduce the temperature of the combustion gas and a plurality of ports 12, 12′ downstream of the injector allows air that bypasses the injector to enter the combustion chamber and further cool the combustion products to a more acceptable temperature for the turbine components.

The combustion chamber 2 is positioned within a combustor casing having a radially inner wall 14 and a radially outer wall 16, where radially inner and radially outer are defined with reference to the general axis of the engine. The casing defines a diffusion area upstream of the combustor where the flow from the compressor is slowed and a radially inner passage 18 and a radially outer passage 20 along which relatively cool air is passed and which enters the combustion chamber through the depicted dilution holes 12, 12′ or through smaller cooling holes (not shown) which allow a film of cool air to be attached to the inside walls of the combustor to protect it from the high temperatures generated by the combustion process.

Thermoacoustic oscillations occur due to the interaction between unsteady heat release and acoustic waves. Unsteady heat release generates sound, and if these acoustic waves are phased appropriately, they will act to alter the inlet flow of fuel and air to the combustor to reinforce the unsteady combustion, resulting in a thermoacoustic instability.

A second ‘entropy wave’ mechanism also contributes to self-excited combustion oscillations in combustors. Unsteady combustion generates ‘hot spots’ which convect downstream, through the combustor outlet, which is nearly choked. The acceleration of these hot spots through the combustor outlet results in pressure waves which propagate upstream and again, depending on the phasing, can act to reinforce oscillatory combustion.

During a combustion oscillation the local pressure in the combustor varies at both the air inlet 10 at the fuel injector and at the dilution ports 12, 12′ downstream of the injector.

Within each of the passages 20, 18, between the combustor and the casing which supply further air to the combustion chamber the flow of air has a standing wave and it has been found that the influence of air mass flow rate perturbations caused by the standing wave at the dilution ports 12, 12′ has a significant effect on the total heat release occurring within the combustor.

It has been found that by adjusting the phase of a perturbation at the dilution port such that the resulting heat release contribution is in anti-phase with that produced by perturbations at the fuel atomiser, then the amplitude of the unsteady combustion within the combustor can be reduced.

The phase of the standing wave in the passage leading to the dilution port is adjusted to lead to unsteady combustion to destructively interact with the unsteady heat release in the combustor.

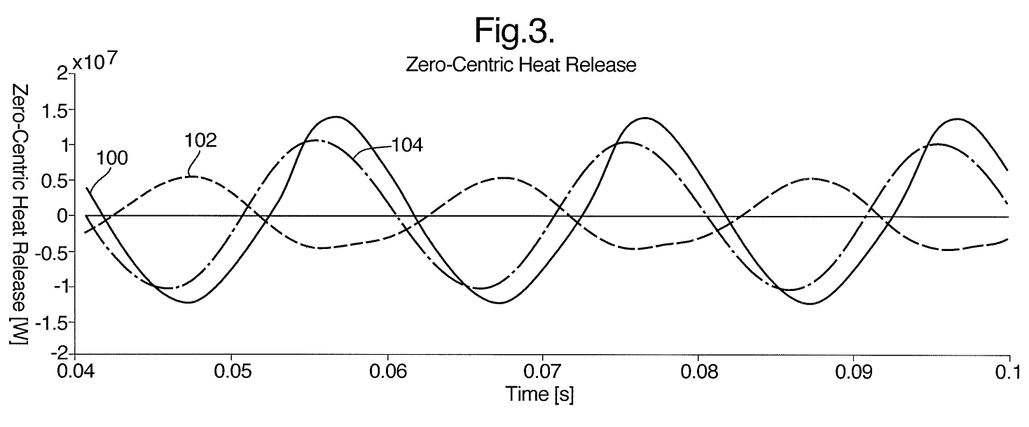

As can be seen from FIG. 3, which depicts the results of detailed computational fluid dynamic calculations, a 50 Hz perturbation in air mass flow rate was imposed at the combustor inlet and simultaneously at the combustor dilution port giving a first acoustic wave measured at the combustor inlet and a second acoustic wave measured at the dilution ports. The pressure at the inlet and dilution port is generally sinusoidal when plotted against time and is depicted in FIG. 3 as trace 100 and 102 respectively.

The combination of the pressure perturbations at the inlet and dilution ports affects the amplitude and phase of the zero centric heat release within the combustor, which is plotted against time as trace 104.

The phase of the perturbation at the dilution port can be adjusted by providing one or more Helmholtz resonators opening into the passageway. In FIG. 1, two resonators are depicted with each resonator having a resonator neck 30 and a variable volume resonator cavity 32. The resonator neck opens into the passageway 18,20 and connects the cavity with the passageway. If active control is desired, a divider 34 may be provided within the cavity which is driven to move within the chamber either hydraulically or electrically using a stepper motor and thereby vary the volume of the chamber and thus the frequency attenuated. It will, of course be understood that a single volume Helmholtz resonator may be used, the volume required being determined during testing or by CFD analysis of the combustor arrangement.

The Helmholtz resonators are mounted to the combustor casing and thus are located in a relatively cool position and further cooling systems to protect this component is not required.

The Helmholtz resonator may adjust the phase, or both the phase and amplitude of the mass flow perturbations of the secondary non-combustible fluid in the passage 20. In the embodiment shown, by adjusting the phase of the standing wave in the passage the effect on heat release caused by these waves is anti-phase to the phase of the heat release caused by the standing wave at the primary inlet.

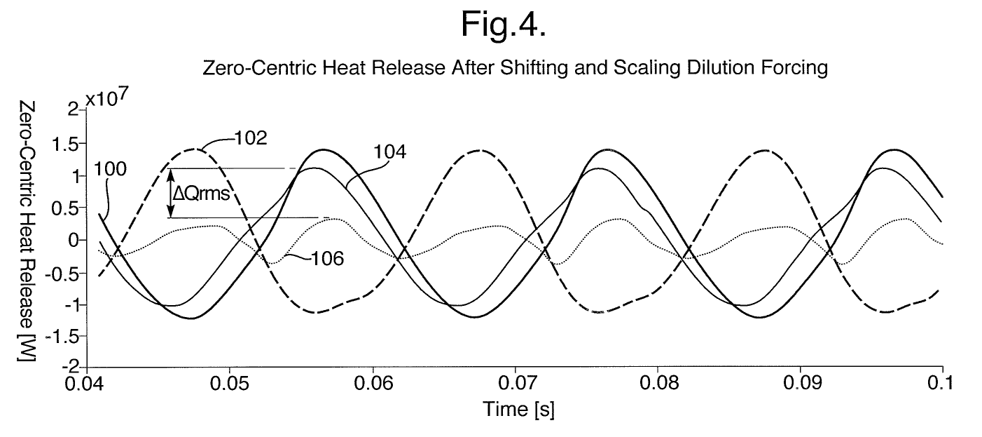

FIG. 4 is a graphical representation of the combustor arrangement plotted with the standing waves 100 at the combustor inlet 4 and the standing wave 102 at the dilution ports after adjustment of its phase and amplitude against time. Also plotted is the zero centric heat release within the combustor as trace 104 and 106 both for the non-adjusted standing wave in the passage and the adjusted standing wave respectively. As may be seen from the graphical representation the amplitude of the zero-centric heat release W of the combustion instability may be reduced by ΔQ_{RMS}=72.8%.

This invention applies to axial instabilities in the combustor and to circumferential and annular modes in the combustor.

If a number of Helmholtz resonators at different circumferential locations are provided they may be used to remove the axi-symmetry of the dilution flow which helps to prevent the formation and growth of circumferential instabilities within the dilution and cooling passage 18, 20.

A further active method and apparatus for adjusting the phase and/or amplitude of perturbations at the dilution port is exemplified in FIG. 2. In this embodiment the geometry of the passage is modulated. One possibility is to use a plunger attached to a ball screw and stepper motor, which is mounted to the closed end of the combustor casing 14 and moves to vary the length of the passage.

The combustor instabilities may be more accurately controlled through semi-active phase tuning of the dilution duct. The geometry of the dilution duct and/or resonator volume is adjusted at a rate governed by how quickly the combustor reacts to changes in dilution forcing. Beneficially, the frequency at which changes must be made are orders of magnitude lower than required in an active control system where the rate of fuel injection is varied.

1. A combustor system for a gas turbine, the system comprising:
a combustion chamber having a primary inlet at an upstream end thereof for the supply of a first volume of air to the combustion chamber and a secondary inlet downstream of the primary inlet for the supply of a second volume of air to the combustion chamber; and
a passage external of the combustion chamber for the supply of air to the secondary inlet;
wherein the phase and amplitude of a standing wave in the passage at the secondary inlet is selected relative to the phase and amplitude of a standing wave at the primary inlet to minimize an amplitude of an unsteady instability in the combustor chamber.

2. A combustor system according to claim 1, wherein the phase of said unsteady combustor chamber instability effected by the standing wave in the passage at the secondary inlet is anti-phase with the phase of the unsteady combustor chamber instability effected by the standing wave at the primary inlet.

3. A combustor system according to claim 1 wherein the amplitude of the unsteady combustor chamber instability effected by the standing wave in the passage at the secondary inlet is substantially the same as the amplitude of unsteady combustion effected by the standing wave at the primary inlet.

4. A combustor system according to claim 1, wherein the passage is defined between an outer wall of the combustor and a casing extending around the combustor, and the system further comprises a Helmholtz resonator having a resonator cavity and a resonator neck that extends between the cavity and the passage and which opens to the passage through an aperture in the casing.

5. A combustor system according to claim 4, wherein the volume of the Helmholtz resonator may be selectively changed to adjust the phase and amplitude of the standing wave in the passage.

6. A combustor system according to claim 1, wherein the passage is defined between an outer wall of the combustor and a casing extending around the combustor, and the system further comprises phase adjusting means for adjusting the phase of the standing wave in the passage.

7. A combustor system according to claim 6, wherein the phase adjusting means simultaneously adjusts the amplitude of the standing wave in the passage.

8. A combustor system according to claim 4, wherein the phase and amplitude adjusting means comprises a wall which is moveable to adjust the length of the passage.

9. A combustor system according to claim 1, wherein the secondary inlet is a dilution port.

10. A combustor system according to claim 1, wherein the primary inlet is a fuel injector.

11. A combustor system according to claim 1, wherein sensor means is provided to detect or calculate the phase and amplitude of the standing wave in the passage at the secondary inlet.

12. A combustor system according to claim 11, wherein the sensor means comprises pressure transducers at the primary and dilution ports.

13. A combustor system for a gas turbine, the system comprising:
a combustion chamber having a primary inlet at an upstream end thereof for the supply of a first volume of air to the combustion chamber and a secondary inlet downstream of the primary inlet for the supply of a second volume of air to the combustion chamber; and
a passage external of the combustion chamber for the supply of air to the secondary inlet;
wherein a Helmholtz resonator is provided having a resonator cavity and a resonator neck, the resonator neck extending between the cavity and the passage for adjusting the phase and amplitude of a standing wave in the passage.

14. A method for reducing the amplitude of instability in a combustion chamber within a combustor system for a gas turbine having a combustion chamber having a primary inlet at the upstream end thereof for the supply of a first volume of air to the combustion chamber and a secondary inlet downstream of the primary inlet for the supply of a second volume of air to the combustion chamber; and
a passage external of the combustion chamber for the supply of air to the secondary inlet;
wherein the method comprises the step of adjusting the phase and amplitude of a standing wave in the passage at the secondary inlet relative to the phase and amplitude of a standing wave at the primary inlet to minimize the amplitude of unsteady instability in the combustor chamber.

15. A method according to claim 14, further comprising the step of adjusting the phase of the standing wave in the passage at the secondary inlet to be anti-phase with the phase of the standing wave at the primary inlet.

16. A method according to claim 14, further comprising the step of adjusting the amplitude of the standing wave in the passage at the secondary inlet to give unsteady combustion to be substantially the same as the amplitude of the standing wave at the primary inlet.

17. A method according to claim 15, wherein the passage is defined between an outer wall of the combustor and a casing extending around the combustor and is provided with a Helmholtz resonator having a resonator cavity and a resonator neck that extends between the cavity and the passage and which opens to the passage through an aperture in the casing, wherein the method comprises the step of adjusting the volume of the resonator cavity to adjust the phase and amplitude of the standing wave in the passage.

18. A method according to claim 15, wherein the passage is defined between an outer wall of the combustor and a casing extending around the combustor and is provided with a moveable end wall that may be moved, wherein the method comprises the step of moving the moveable end wall to adjust the length of the passage to adjust the phase and amplitude of the standing wave in the passage.
